(19) United States
(12) Patent Application Publication
(10) Pub. No.: US 2016/0064914 A1
(43) Pub. Date: Mar. 3, 2016

(54) System and Method for Forming End Terminations of Mineral Insulated Cable

(71) Applicant: Pentair Thermal Management LLC, Menlo Park, CA (US)

(72) Inventors: Aron Janvrin, Georgetown (CA); Gary White, Belleville (CA); Helene Raymond, Grafton (CA); David Parman, San Ramon, CA (US)

(21) Appl. No.: 14/841,450

(22) Filed: Aug. 31, 2015

Related U.S. Application Data
(60) Provisional application No. 62/044,239, filed on Aug. 30, 2014.

(51) Int. Cl. H02G 15/04; H02G 1/14

(52) U.S. Cl. CPC H02G 15/04; H02G 1/14

(57) ABSTRACT

A method of attaching an end termination assembly to a cold lead of a mineral insulated heating cable. the method comprises removing a portion of a metallic sheath of the cold lead from a proximal end of the cold lead, thereby exposing a conductor of the cold lead. In addition sliding a tubular bushing over the proximal end of the cold lead, and sliding a tubular pot over the proximal end of the cold lead, the conductor thereby projecting from a proximal end of the tubular pot. The method further including aligning a proximal end of the sheath of the cold lead with a proximal end of the tubular bushing, and welding the proximal end of the tubular bushing to the sheath at the proximal end of the sheath. In addition, positioning a distal end of the pot over the proximal end of the bushing, and welding the distal end of the pot to the bushing.

### CROSS-REFERENCE TO RELATED APPLICATIONS

This application claims the benefit under 35 U.S.C. §119(e) of U.S. Provisional Application Ser. No. 62/044,239 entitled SYSTEM AND METHOD FOR FORMING END TERMINATION OF MINERAL INSULATED CABLE, filed, Aug. 30, 2014 which is incorporated herein by reference in its entirety and to which this application claims the benefit of priority.

### BACKGROUND

“Downhole heating” refers to the known practice of providing apparatuses and systems that can be installed in an oil or gas well to heat the well, (a) pipeline(s) within the well, or process media (e.g., oil) retrieved from the well. The well can be thousands of feet deep, and the wellhead can be on land or underwater. In these environments the atmospheric pressure at the wellhead and down the well can be extremely high.

One type of downhole heating apparatus uses an electric heating cable, or a group or series thereof, to provide thermal energy to the components or media being heated. Electric heating cables connect to a power source and convert an electric current into thermal energy using several known cable structures. One such structure is a mineral-insulated (MI) electric heating cable. A typical MI cable has a round or oval cross-section with several layers. One or more conductors at or near the center of the cable are surrounded by the mineral insulation, which is typically magnesium oxide. The mineral insulation is tightly packed inside a conductive, typically copper or steel, tubular sheath, which in turn may be covered by an insulating polymer or braided overjacket.

Several MI cables are often spliced together to achieve the necessary length for downhole heating, or to provide zones of differing heating parameters. Near the wellhead, the MI cable is attached to a cold lead, which has a similar composition to the MI cable, including one or more conductors packed with inorganic insulation in a metal sheath. The cold lead is so-called because it does not emit significant thermal energy like the heating cables do. The cold lead is attached at its distal end to the MI cable, and at its proximal end the cold lead must be “terminated” by attaching the cold lead conductor(s) to one or more wires that in turn connect to the heating cable power supply. This termination may be exposed to the surrounding environment, and so must be sealed against ingress of environmental substances, even in high pressure locations.

Current MI cable terminations are typically wiring kits that include o-ring housings, formed-in-place mastic or epoxy seals, brass, nickel-plated or steel multi-component gland and ferrule assemblies, or combinations thereof. These kits form a seal on the cold lead cable sheath via brazing or application of sealing compound to the sheath. Unfortunately, brazed or epoxied seals against the sheath, while the best existing method, can fail in high pressure environments, or with exposure to corrosive gases and fluids often found in the downhole environment. An improved MI cable end termination for high pressure environments is needed.

### SUMMARY

The present methods and apparatuses provide a tungsten inert gas (TIG) welded seal between the cold lead cable sheath and the end termination, which makes other types of sealing locations and features (other than the cable sheath) possible.

A method of attaching an end termination assembly to a cold lead of a mineral insulated heating cable is disclosed. The method comprising removing a portion of a metallic sheath of the cold lead from a proximal end of the cold lead, thereby exposing a conductor of the cold lead. The method further comprising sliding a tubular bushing over the proximal end of the cold lead, the tubular bushing having a shoulder, the shoulder having a diameter adjacent and proximal to a distal end of the tubular bushing, the tubular bushing having a first portion with a first inner diameter adjacent to a distal end of the tubular bushing and a second portion with a second inner diameter adjacent to a proximal end of the tubular bushing. Additionally, the method comprises sliding a tubular pot over the proximal end of the cold lead, the conductor thereby projecting from a proximal end of the tubular pot, the tubular pot having a length, measured from a distal end of the tubular pot to the proximal end of the tubular pot, that is longer than the distance from the shoulder of the tubular bushing to the distal end of the tubular bushing, the tubular pot having a first portion with a first inner diameter, the first inner diameter approximately equal to a first outer diameter of the tubular bushing. Further, the method comprises aligning a proximal end of the sheath of the cold lead with a proximal end of the tubular bushing; welding the proximal end of the tubular bushing to the sheath at the proximal end of the sheath; positioning a distal end of the tubular pot over the proximal end of the tubular bushing; and welding the distal end of the tubular pot to the tubular bushing.

Additionally, a further method of attaching an end termination assembly to a cold lead of a mineral insulated heating cable is disclosed. The method comprises, sliding a tubular bushing over a proximal end of the cold lead; sliding a tubular pot over the proximal end of the cold lead; welding a proximal end of the tubular bushing to a proximal end of a metallic sheath of the cold lead; and welding a distal end of the tubular pot to the tubular bushing.

Furthermore, an end termination assembly for a mineral insulated heating cable is disclosed. The end termination assembly comprises a tubular bushing, the tubular bushing having a shoulder, the shoulder having a diameter adjacent and proximal to the distal end of the tubular bushing, the tubular bushing having a first portion with a first inner diameter adjacent to a distal end of the tubular bushing and a second portion with a second inner diameter adjacent to a proximal end of the tubular bushing. The end termination assembly further comprises a tubular pot having a length, measured from a distal end of the tubular pot to a proximal end of the tubular pot, that is longer than the distance from the shoulder of the tubular bushing to the proximal end of the tubular bushing, the tubular pot configured to be welded to the tubular bushing at the distal end of the tubular pot, the tubular pot having a first portion with a first inner diameter, the first inner diameter approximately equal to an outer diameter of the second portion of the tubular bushing.

### DESCRIPTION OF THE DRAWINGS

FIG. 1 is a perspective view of a mineral insulated cold lead cable having an exposed conductor.

FIG. 2 is a top view of a bushing in accordance with an embodiment of the disclosure.

FIG. 3 is a right side cross-sectional view of the bushing taken along line A-A of FIG. 2.

FIG. 4 is a top view of a pot in accordance with an embodiment of the disclosure.

FIG. 5 is a right side cross-sectional view of the pot taken along line C-C of FIG. 4.

FIG. 6A is a right side view of a splice assembly in accordance with an embodiment of the disclosure, attached to a cold lead sheath.

FIG. 6B is a right side partial cross-sectional view of the splice assembly of FIG. 6A.

FIG. 6C is a right side full cross-sectional view of the splice assembly of FIG. 6A.

FIG. 7 is a flow chart illustrating a method of forming a mineral insulated cable end termination in accordance with the present disclosure.

FIG. 8 is a right side partial cross-sectional view of the splice assembly of FIG. 6 with a terminating cap attached.

FIG. 9 is a right side partial cross-sectional view of the splice assembly of FIG. 6 with a locking assembly attached.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

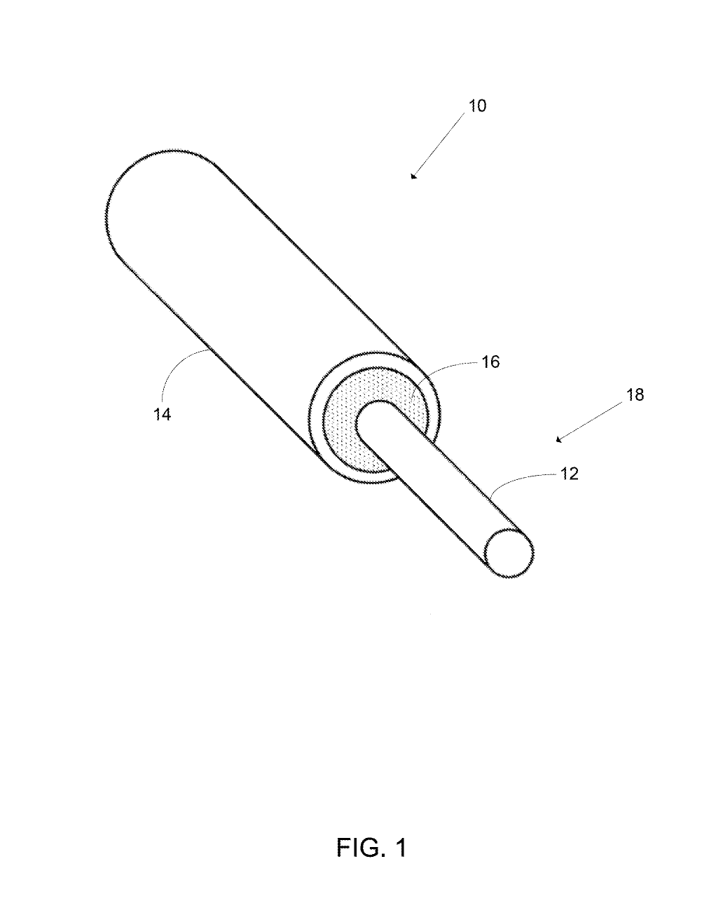

FIG. 1 illustrates the proximal (i.e., wellhead) end of a typical mineral insulated (“MI”) cable cold lead 10 that may be spliced to one or more power-transfer conductors, such as insulated wires known as “tails,” using the present methods and apparatuses. It will be understood, however, that the present methods and apparatuses may form end terminations for other cables (e.g., a multi-core MI cable having a plurality of conductors) as well as for other cold leads. The cold lead 10 includes a conductor 12 running the length of the cold lead 10 coaxially within a cylindrical metal sheath 14. The sheath 14 can be constructed using copper, stainless steel, etc. In some embodiments, the sheath 14 can be a solid metallic sleeve. In other embodiments, the sheath 14 can be a woven metallic covering. In some embodiments, the intervening space within the sheath 14 can be filled with an inorganic insulator 16. In one example, the inorganic insulator 16 can be magnesium oxide. At a proximal end 18 of the cable 10, a length of the conductor 12 can be exposed, such as by stripping off a portion of the sheath 14 and the insulator 16. The length of exposed conductor 12 can provide a connection surface for an end termination. For example, the length of exposed conductor 12 can be connected to an insulated power-transfer conductor or “tail.” The cold lead 10 may be any suitable MI cable cold lead, using any known materials.

The present methods and apparatuses provide a welded seal between the cold lead 10 sheath 14 and an end termination assembly. The welded seal can be far stronger than existing cold lead termination seals as known in the art. Further, the welded seal methods and apparatuses described herein can make other types of sealing locations and features apart from the sheath 14 possible. The welds described herein may be formed using any suitable welding processes, except where identified. Preferably, TIG welding, electron welding, or laser beam welding can be used.

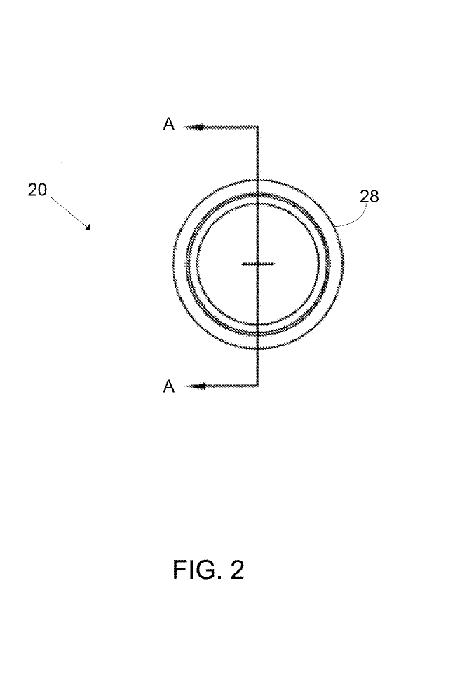

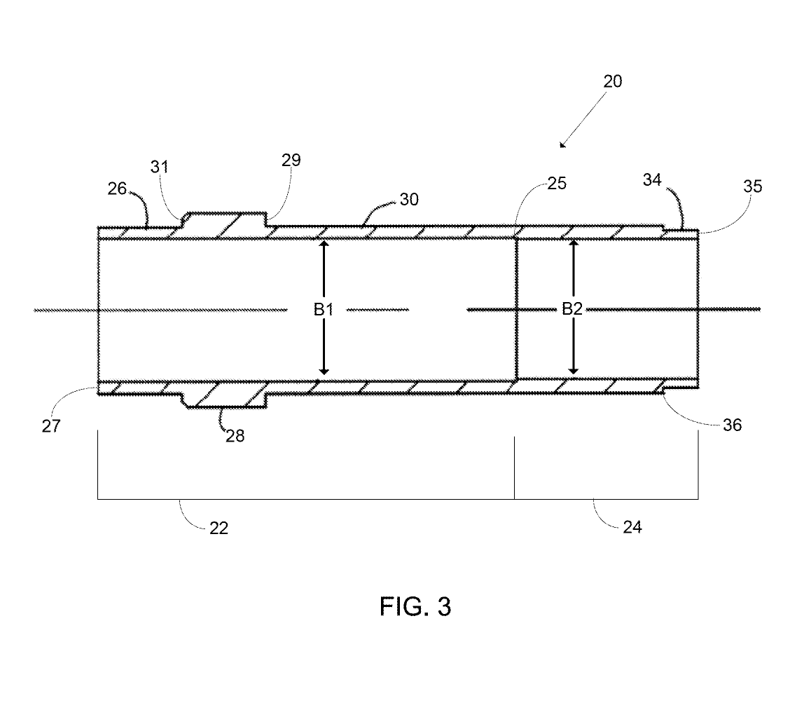

Referring to FIGS. 2 and 3, an end termination assembly may include a bushing 20. The bushing 20 can be welded to the outside sheath 14 of the cold lead 10 of a mineral insulated cable. The bushing 20 can be constructed of any suitable metal for welding with the sheath 14. In one embodiment, the bushing 20 material can be selected to provide pressure and corrosion resistance. Non-limiting examples of the bushing 20 material can include copper, stainless steel, iron, or other applicable materials. In one embodiment, the bushing 20 material can be constructed of the same material as the sheath 14 material.

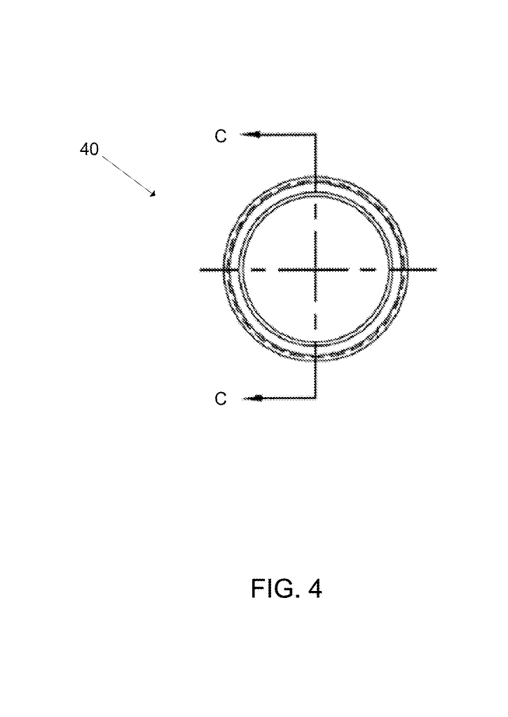

The bushing 20 may be substantially tubular with a first portion 22 having a first inner diameter B1 that is slightly larger than an outer diameter of the sheath 14, to allow the bushing 20 to be more easily positioned over the sheath 14. The sheath 14 can typically be straightened by hand, and therefore susceptible to binding up while sliding through the bushing 20 having close tolerances along its entire length. A second portion 24 of the bushing 20, proximal to the first portion 22 may have a second inner diameter B2. The second inner diameter B2 can be about equal to an outer diameter of the sheath 14. This close tolerance can provide adjacent surfaces of the bushing 20 and sheath 14 to be in contact. This contact between the bushing 20 and the sheath 14 can increase a quality of a weld, as described below. An inner shoulder 25 can transition between the first inner diameter B1 and the second inner diameter B2. The outer surface of the bushing 20 may have several diameters. A diameter of a distal portion 26 of the outer surface of the bushing 20 can be selected to provide structural stability to the bushing 20. Additionally, a thickness of the distal portion 26 can provide sufficient material for forming a distal weld, if one is used. The distal portion 26 can end at a distal end 27. A diameter of a shoulder 28 of the outer surface of the bushing 20 can be adjacent and proximal to the distal portion 26. The diameter of the shoulder 28 may be selected to project outward from the outer surface of the bushing 20, with a sufficient distance to receive a pot 40 (see FIG. 4), as described below. In one embodiment, a proximal end 29 of the shoulder 28 can be left as a sharp edge during manufacturing to provide a suitable surface for welding. In one embodiment, the distal portion 26 can have a length, the length equal to a distance between the distal end 27 of the bushing 20 and a distal end 31 of the shoulder 28. In one example, the length of the distal portion 26 can be about 0.32 inches. Alternatively, the length of the distal portion 26 can be about 10% to about 20% of the total length of the bushing 20.

A diameter of a main portion 30 of the bushing 20 can be adjacent and proximal to the shoulder 28. In one embodiment, the outer diameter of the main portion 30 can be selected to abut an inner surface of the pot 40 when it is positioned over the bushing 20, as described below. A diameter of a proximal portion 34 may be selected so that the thickness of the bushing 20 at the proximal portion 34 approximately matches the thickness of the cold lead 10 sheath 14. For example, the thickness of the bushing 20 at the proximal portion 34 can be plus or minus 15% of the thickness of the sheath 14. In some examples, a more uniform and higher quality weld can be achieved when the thickness of the sheath 14 and the bushing 20 are approximately the same. In one embodiment, the proximal portion 34 can be about 0.35 inches in length to about 0.39 inches in length. Alternatively, the length of the proximal portion 34 can be about 15% to about 20% of the total length of the bushing 20. The proximal portion 34 can terminate at a proximate end 35. A proximal shoulder 36 can be used to transition between the outer diameter of the second portion 24 and the outer diameter at the proximal portion 34. In one embodiment, the proximal shoulder 36 can be a straight, 90° angle. Alternatively, the proximal shoulder 36 can be tapered at an angle less than 90°.

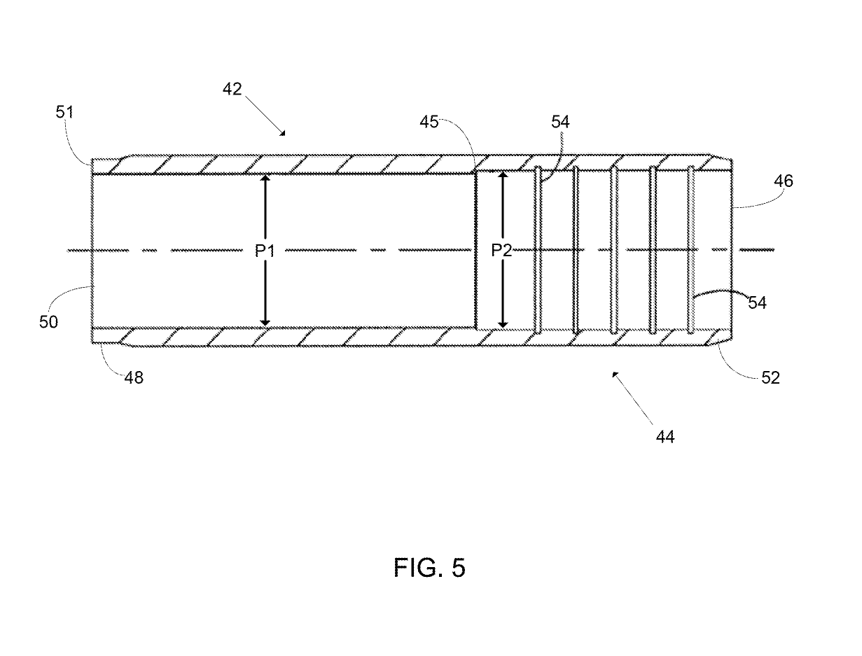

Referring to FIGS. 4 and 5, the end termination assembly may further include a pot 40. The pot 40 can serve as a shell for enclosing a splice between the conductor 12 of the cold lead 10 and another conductor (not shown). The pot 40 can be constructed of any suitable metal for welding with the bushing 20 and for providing pressure and corrosion resistance. As non-limiting examples, the pot 40 can be constructed of copper, stainless steel, iron, or other applicable materials. The pot 40 can be substantially tubular with a first portion 42 having a first inner diameter P1. In one embodiment, the first inner diameter P1 can be approximately equal to the outer diameter of the main portion 30 of the bushing 20. A second portion 44 proximal to the first portion 42 can have an inner diameter P2 that is larger than P1. In some embodiments, the first portion 42 of the pot 40 may have a length approximately equal to the distance from the proximal end 35 of the bushing 20 to the shoulder 28, so that the proximal end 35 of the bushing 20 approximately abuts the second portion of the pot 40, when the pot 40 is slid in place over the bushing 20 as described below. A transition shoulder 45 can be used to transition between the first portion 42 and the second portion 44. In one embodiment, the proximal end 35 of the bushing 20 can extend into the second portion 44 of the pot 40. This can create a void between the proximal portion 34 of the bushing and the second inner diameter P2 of the pot 40, for the length of the proximal portion 34 extending into the second portion 44 of the pot. This void can be filled with an epoxy or adhesive insulation when applied to the pot 40, as described below.

The outer surface of the pot 40 may be uniform in diameter, except for a first tapered portion 48 at a distal end 50 and a second tapered portion 52 at the proximal end 46. The first tapered portion 48 and the second tapered portion 52 can have small lengths in comparison to the length of the pot 40. For example, the length of the first tapered portion 48 can be about 6% to about 10% of the total length of the pot 40. In another example, the length of the second tapered portion 52 can be about 3% to about 5% of the total length of the pot 40. In one embodiment, the lengths of the tapered portions 48, 52 can be about 0.09 inches to about 0.25 inches. The angle of the taper of the first tapered portion 48 and the second tapered portion 52 can have a taper angle of about 15%. The tapered portions 48, 52 can have reduced outer diameters in relation to the rest of the outer surface of the pot 40. In one embodiment, the second tapered portion 52 may be beveled at the proximal end 46, the outer surface reducing in diameter over the second tapered portion 52. In a further embodiment, the first tapered portion 48 can have a reduced diameter at the distal end 50 to provide an optimal thickness for welding. This thickness can be between about 10% and about 20% of the outer diameter of the first portion 42. Additionally, a distal edge 51 of the first tapered portion 48 can be left as a sharp edge during manufacturing to facilitate welding. The second portion 44 of the pot 40 may further include one or more grooves 54 in the inner surface of the pot 40. The grooves 54 may be configured to retain a sealing material, such as epoxy, to create a pot seal as described below. In some embodiments, the outer surface of the pot 40 can have a surface treatment (not shown). The surface treatment can provide protection against corrosion. Alternatively, the surface treatment can prevent scratching or marring of the pot.

The design of the bushing 20 and pot 40 should meet specific criteria to be able to be welded to the sheath 14 and to each other, and then sealed as described below. For example, the treatment of edges between intersecting surfaces can affect the ease with which parts are slid over each other, as well as the quality of the welds at certain points. In some embodiments, edges that will be welded may be left sharp to provide material for forming the weld, and edges that are not welded may be trimmed to minimize snagging and cutting hazards.

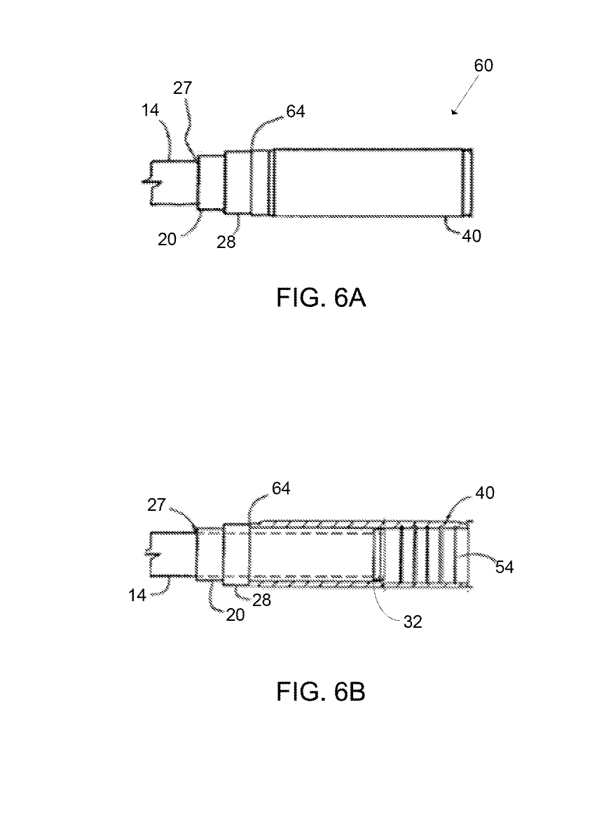

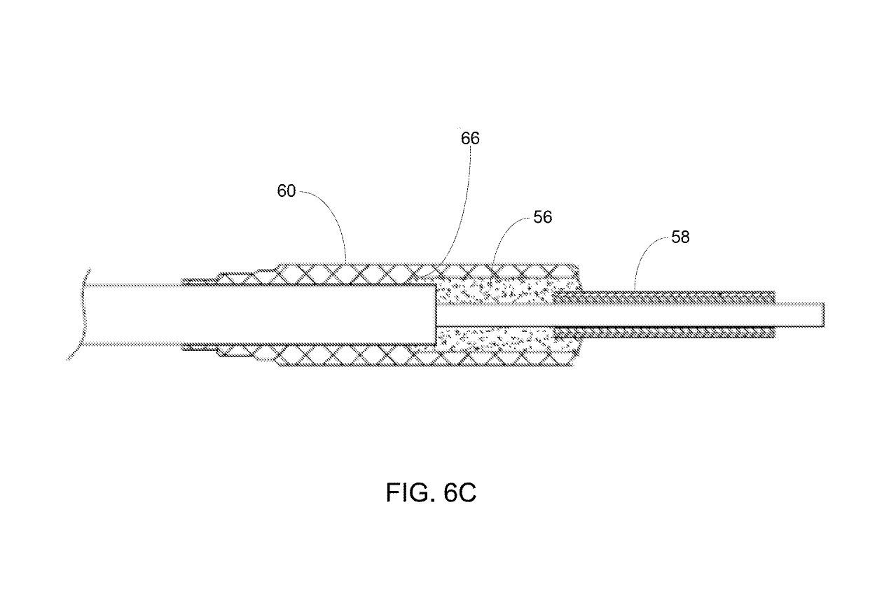

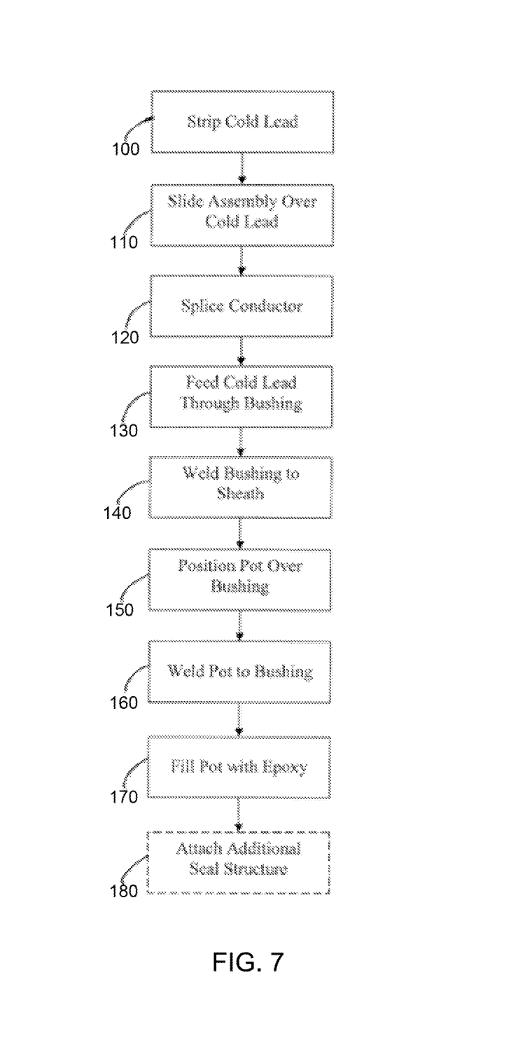

FIGS. 6A, 6B and 6C illustrate an end termination assembly 60 including the bushing 20 and the pot 40. FIG. 8 illustrates an example method for attaching the end termination assembly 60 to the cold lead 10. At step 100, the cold lead 10 can be stripped at its proximal end to expose the desired length of conductor 12. At step 110, the bushing 20 and the pot 40 can be slid over the proximal end of the cold lead 10 until the exposed conductor 12 projects from the proximal end of the pot 40. At step 120, the conductor 12 may be spliced to the tail(s), cable conductor, or other conductor using any suitable conductor splicing technique, such as crimping, soldering, and the like.

At step 130, the cold lead 10 can be fed distally back through the bushing 20 until the exposed conductor 12 projects from the proximal end of the bushing 20 and the proximal end of the sheath 14 is approximately or entirely flush with the proximal end 35 of the bushing 20. In this position, the splice of the conductor 12 will be inside the pot 40. At step 140, the bushing 20 can be welded to the sheath 14 at the proximal end of the bushing 20. In another embodiment, the bushing 20 can be welded to the sheath at the proximal ends of each component, particularly at the proximal end 35 of the bushing 20. The bushing 20 can also be welded to the sheath 14 at a distal end 27 of the bushing 20. Alternatively, the bushing 20 can be brazed to the sheath 14 at a distal end 27 of the bushing 20 to provide strain relief at the distal end 27. Welding the bushing 20 to the sheath 14 at the distal end 27 can provide a “backup” seal to support the weld at the proximal portion 32 of the bushing 20. At step 150, the pot 40 can be positioned over the bushing 20 so that the distal end 50 of the pot 40 contacts the shoulder 28 of the bushing 20. At step 160, the pot 40 can be welded to the bushing 20 at the distal end 50 of the pot 40. In one embodiment, the pot 40 can be welded to the bushing 20 at the intersection 64 of the distal end 50 of the pot 40, and the shoulder 28 of the bushing 20. An electron beam or laser beam weld can be used to weld the bushing 20 and the pot 40. Alternatively, other welding techniques, such as TIG welding, can be used to weld the bushing 20 and the pot 40.

In other embodiments, the pot 40 can be welded to the bushing 20 as described above before the assembly 60 is slid over the cold lead 10. Where the pot 40 is welded to the bushing 20, prior to the assembly 60 being slid over the cold lead, the sheath 12 would be welded to the bushing 20 at the distal end only. In other embodiments, the bushing 20 and pot 40 can both be welded as in steps 140 and 160 above before the splice (step 120) is completed.

Referring again to FIG. 8, at step 170 the open proximal end 46 of the pot 40 can be partially or completely filled with an insulating adhesive 56. The insulating adhesive 56 can be seen in FIG. 6C. The insulating adhesive 56 can be used to coat, secure and protect the splice. The insulating adhesive 56 can create a hermetic seal which can be used to protect the insulation material of the mineral insulated cable from degrading over time. The insulating adhesive 56, prior to curing, can cover the splice and flow into the grooves 42 to create a tight seal. In one embodiment, the insulating adhesive 56 can be an epoxy or similar temperature-resistant insulating adhesive. Additionally, polymers, such as DURALCO and/or other polyether ether ketone can be used to create the hermetic seal. These polymers, however, are typically not resistant to harsh chemicals or high pressure, especially if the environment is warm. In a preferred embodiment, the pot 40 can be welded to the bushing 20 to form a sealed and protected space for the insulating adhesive 56. In a further embodiment, a high temperature heat shrink 58 can be applied to the conductor 12 to provide strain relief to the conductor 12 where it leaves the insulating adhesive 56. Further, the high temperature heat shrink can also provide additional electrical insulation between the conductor 12 and the pot 40. In one example, the high temperature heat shrink 58 can be a fluoropolymer, such as Sumitube® KH 230. Further, FIG. 6C illustrates a void 66 between the sheath 14 and proximal portion 34 of the bushing, as discussed above. The adhesive insulation 56 can therefore surround the sheath 14 as shown in FIG. 6C. This can provide an additional seal between the pot 40 and the proximal portion 34 of the bushing 20.

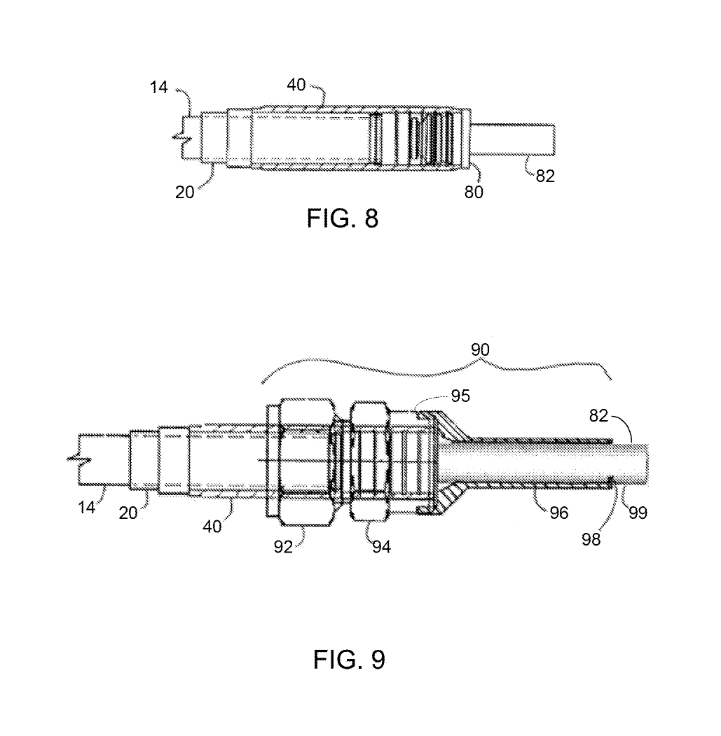

Optionally, the outer surface of the insulating adhesive 56 at the proximal end 46 of the pot 40 can be used to connect (step 180 of FIG. 8) another environmental seal. The additional environmental seal can be used to provide additional protection against high pressures and harsh chemicals. Referring to FIG. 9, a additional environmental seal can be seen in the form of a terminator cap 80. The terminator cap 80 can be attached to a stub tube 82. In one embodiment, the stub tube 82 can be inserted into the proximal end 46 of the pot 40. In one embodiment, the stub tube 82 can be a hollow tube which can allow for one or more conductors (not shown) to pass through the stub tube 82 to the terminator cap 80. Additionally, one or more conductors (not shown) may project distally from the terminator cap 80 for splicing with the conductor 12 of the cold lead 10. In one embodiment, the terminator cap 80 can be welded or otherwise sealed against the proximal end 46 of the pot 40. Alternatively, the terminator cap 80 can have grooves which can correspond to the grooves 54 of the pot 40. The grooves of the terminator cap 80 can matedly couple with the grooves 54 of the pot 40 to seal the terminator cap 80 to the pot 40.

Referring to FIG. 10, a SWAGELOK or ferrule gland locking system 90 can be used. A back nut 92 may tighten against the pot 40 using a ferrule (not shown), as is known in the art, by matedly threading with a front nut 94. An adapter 96 may be welded to the front nut 94 at point 95. The adapter 96 includes a bore 98 that conforms and can be attached to a sleeve 99 of the stub tube 82. Threading the nuts 92, 94 together tightly can relieve strain on the splice within the pot 40. In one embodiment, the back nut 92 can be welded to pot 40. Finally, other known sealing methods, such as oil field pressure balance sealing methods can be used as well to seal the proximal end 46 of the pot 40.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Finally, it is expressly contemplated that any of the processes or steps described herein may be combined, eliminated, or reordered. Accordingly, this description is meant to be taken only by way of example, and not to otherwise limit the scope of this invention.

1. A method of attaching an end termination assembly to a cold lead of a mineral insulated heating cable, the method comprising:
removing a portion of a metallic sheath of the cold lead from a proximal end of the cold lead, thereby exposing a conductor of the cold lead;
sliding a tubular bushing over the proximal end of the cold lead, the tubular bushing having:
a first portion extending from a distal end of the tubular bushing and having an outer surface at a first outer diameter and an inner surface at a first inner diameter, the first portion comprising a shoulder extending from the outer surface to a second outer diameter larger than the first outer diameter; and
a second portion extending from the first portion to a proximal end of the tubular bushing and having an outer surface at the first outer diameter and an inner surface at a second inner diameter smaller than the first inner diameter;
sliding a tubular pot over the proximal end of the cold lead, the conductor thereby projecting from a proximal end of the tubular pot, the tubular pot having a length, measured from a distal end of the tubular pot to the proximal end of the tubular pot, that is longer than the distance from the shoulder of the tubular bushing to the proximal end of the tubular bushing, the tubular pot having a first portion with a first inner diameter, the first inner diameter of the tubular pot being approximately equal to the first outer diameter of the tubular bushing;
aligning a proximal end of the sheath of the cold lead with a proximal end of the tubular bushing;
welding the proximal end of the tubular bushing to the sheath at the proximal end of the sheath;
positioning a distal end of the tubular pot over the proximal end of the tubular bushing; and
welding the distal end of the tubular pot to the tubular bushing.

2. The method of claim 1, further comprising filling the tubular pot with an insulating adhesive through a proximal end of the tubular pot subsequent to welding the proximal end of the tubular bushing to the sheath.

3. The method of claim 1, further comprising sealing a proximal end of the tubular pot with a terminating plug.

4. The method of claim 1, further comprising welding the distal end of the tubular bushing to the sheath.

5. A method of attaching an end termination assembly to a cold lead of a mineral insulated heating cable, the method comprising:
sliding a tubular bushing over a proximal end of the cold lead;
sliding a tubular pot over the proximal end of the cold lead;
welding a proximal end of the tubular bushing to a proximal end of a metallic sheath of the cold lead; and
welding a distal end of the tubular pot to the tubular bushing.

6. The method of claim 5, further comprising filling the tubular pot with an insulating adhesive through a proximal end of the tubular pot subsequent to welding the proximal end of the tubular bushing to the sheath.

7. The method of claim 5, wherein the tubular bushing includes a shoulder, the shoulder having a diameter adjacent and proximal to a distal end of the tubular bushing.

8. The method of claim 7, wherein the tubular pot slides over the tubular bushing such that the distal end of the tubular pot is positioned to abut and be welded to the shoulder of the tubular bushing.

9. The method of claim 7, wherein the shoulder is positioned a pre-determined distance from the distal end of the tubular bushing.

10. An end termination assembly for a mineral insulated heating cable, the end termination assembly comprising:
a tubular bushing having an outer surface at a first outer diameter, and further having a shoulder disposed between a proximal end of the tubular bushing and a distal end of the tubular bushing, the shoulder extending from the outer surface to a second outer diameter larger than the first outer diameter; and
a tubular pot having a length, measured from a distal end of the tubular pot to a proximal end of the tubular pot, that is longer than the distance from the shoulder of the tubular bushing to the proximal end of the tubular bushing, the tubular pot configured to be welded to the tubular bushing at the distal end of the tubular pot, the tubular pot having a first portion with a first inner diameter, the first inner diameter approximately equal to an outer diameter of the second portion of the tubular bushing.

11. The end termination assembly of claim 10, wherein the end termination assembly is formed by aligning a proximal end of a metallic sheath of the mineral insulated cable with the proximal end of the tubular bushing, welding a proximal end of the tubular bushing to the sheath at the proximal end of the sheath, positioning the distal end of the tubular pot over the proximal end of the tubular bushing; and welding the distal end of the tubular pot to the tubular bushing.

12. The end termination assembly of claim 11, wherein the tubular pot slides over the tubular bushing such that the distal end of the tubular pot is positioned to abut and be welded to the shoulder of the tubular bushing.

13. The end termination assembly of claim 11, wherein the tubular bushing and the tubular pot are constructed of the same material as a sheath of the mineral insulated heating cable.

14. The end termination assembly of claim 13, wherein the material is one of copper and stainless steel.

15. The end termination assembly of claim 11, wherein the tubular pot has a tapered portion at the distal end of the tubular pot with a reduced diameter to facilitate welding the first end of the tubular pot to the tubular bushing.

16. The end termination assembly of claim 11, wherein a thickness of the proximal end of the tubular bushing is about the same thickness as a sheath of the mineral insulated heating cable.

17. The end termination assembly of claim 10, wherein the tubular bushing further comprises a first portion including the shoulder and having a first inner diameter, and a second portion with a second inner diameter smaller than the first inner diameter.

18. The end termination assembly of claim 17, wherein the second portion of the tubular pot includes a plurality of grooves.

19. The end termination assembly of claim 17, wherein the second portion of the tubular pot is filled with an adhesive insulation.

20. The end termination assembly of claim 10, wherein the first portion of the tubular pot has a length less than the distance from the proximal end of the tubular bushing to the shoulder of the tubular bushing.
